(19) United States
(12) Patent Application Publication
(10) Pub. No.: US 2010/0289902 A1
(43) Pub. Date: Nov. 18, 2010

(54) TESTING SYSTEM AND METHOD FOR VIDEO CHIP

(75) Inventors: Hou-Hsien Lee, Tu-Cheng (TW); Chang-Jung Lee, Tu-Cheng (TW); Chih-Ping Lo, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/482,398

(22) Filed: Jun. 10, 2009

(30) Foreign Application Priority Data
May 13, 2009 (CN) 200910302269.4

(51) Int. Cl. H04N 17/00; G06F 19/00

(52) U.S. Cl. 348/180; 702/82; 348/E17.001

(57) ABSTRACT

A testing system for a video chip to be tested stores a video file in advance. At first, the testing system using a sample video chip to play the video file and outputs first video data. Then a video chip to be tested is installed into the testing system to play the video file and outputs second video data. The first video data and the second video data are compared to determine whether the video chip to be tested is acceptable or not and a control signal is outputted according to the comparison to control a robotic arm to place the video chip to be tested at a determined place.

### BACKGROUND

1. Technical Field

The present disclosure relates to testing systems and methods, and particularly to a testing system and a testing method for a video chip.

2. Description of Related Art

In a conventional testing system for a video chip, the video chip to be tested is installed in a media player to play a video file stored in a disk, to check if the video chip functions properly or not. However, the media player must be stopped when another video chip to be tested is being installed into the media player, and then started again. Repeated stopping and restarting of the media player is time-consuming.

### BRIEF DESCRIPTION OF THE DRAWINGS

FIG. 1 is a block diagram of an exemplary embodiment of a testing system for a video chip.

FIG. 2 is a flowchart of an exemplary embodiment of a testing method for a video chip.

### DETAILED DESCRIPTION

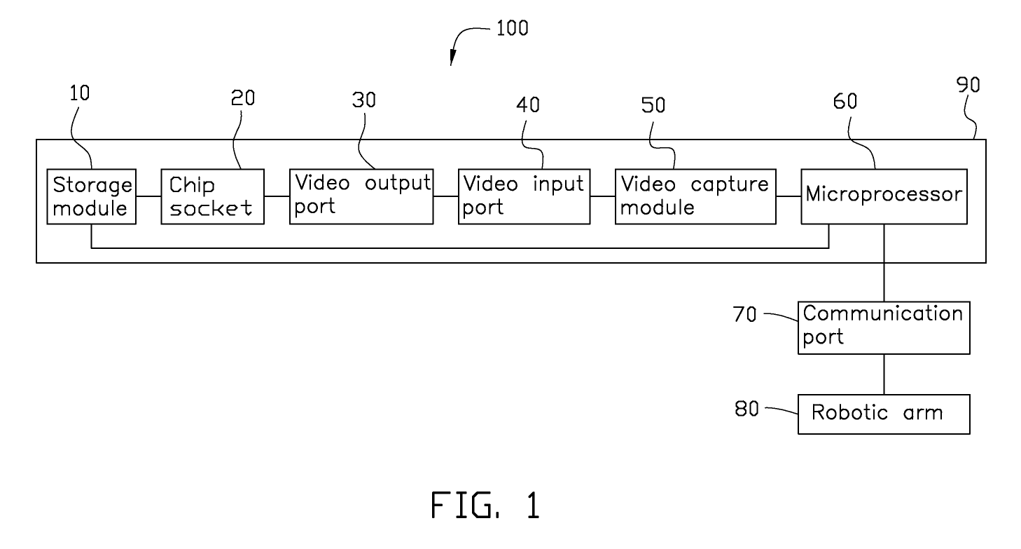

Referring to FIG. 1, an exemplary embodiment of a testing system 100 for a video chip includes a storage module 10, a chip socket 20, a video output port 30, a video input port 40, a video capture module 50, a microprocessor 60, a communication port 70, and a robotic arm 80. The storage module 10, the chip socket 20, the video output port 30, the video input port 40, the video capture module 50, and the microprocessor 60 are connected in series, and installed on a computer motherboard 90. The storage module 10 is also connected to the microprocessor 60. The communication port 70 is connected between the microprocessor 60 and the robotic arm 80. In one exemplary embodiment, the video output port 30 and the video input port 40 can be respectively integrated into the chip socket 20 and the video capture module 50.

In use, a video file is stored in the storage module 10. A video chip conforming to requirements functioning as a sample video chip is installed to the chip socket 20 to play the video file stored in the storage module 10. A first video signal output from the video output port 30 is transmitted to the video capture module 50 via the video input port 40. The video capture module 40 captures first video data of the first video signal, such as audio frequencies, video frequencies, and/or frame frequencies, and so on. The first video data are transmitted to the microprocessor 60, and stored in the storage module 10 via the microprocessor 60.

The robotic arm 80 replaces the sample video chip installed in the chip socket 20 with a video chip to be tested, to play the video file stored in the storage module 10 with the video chip as a second video signal. The second video signal output from the video output port 30 is transmitted to the video capture module 50 via the video input port 40. The video capture module 50 captures second video data of the second video signal, and transmits the second video data in a format the same as that of the first video data to the microprocessor 60.

The microprocessor 60 compares the second video data with the first video data stored in the storage module 10. When a difference between the first and the second video data exceeds a determined value, the video chip to be tested is determined to be unacceptable; thereby the microprocessor 60 outputs a first control signal to control the robotic arm 80 to place the video chip to be tested at a first determined place.

When the difference between the first and the second video data does not exceed a determined value, the video chip to be tested is determined to be acceptable, thereby the microprocessor 60 outputs a second control signal to control the robotic arm 80 to place the video chip to be tested at a second determined place.

At the end of a test, the robotic arm 80 takes the tested video chip away from the chip socket 20, and installs another video chip to the chip socket 20 for a next test.

In the testing system 100 above-mentioned, the video chip to be tested is hot plugged into the chip socket 20 and the video file is stored in the storage module 10 of the computer motherboard 90, thereby the testing system 100 does not need to be stopped and then restarted when another video chip needs to be tested.

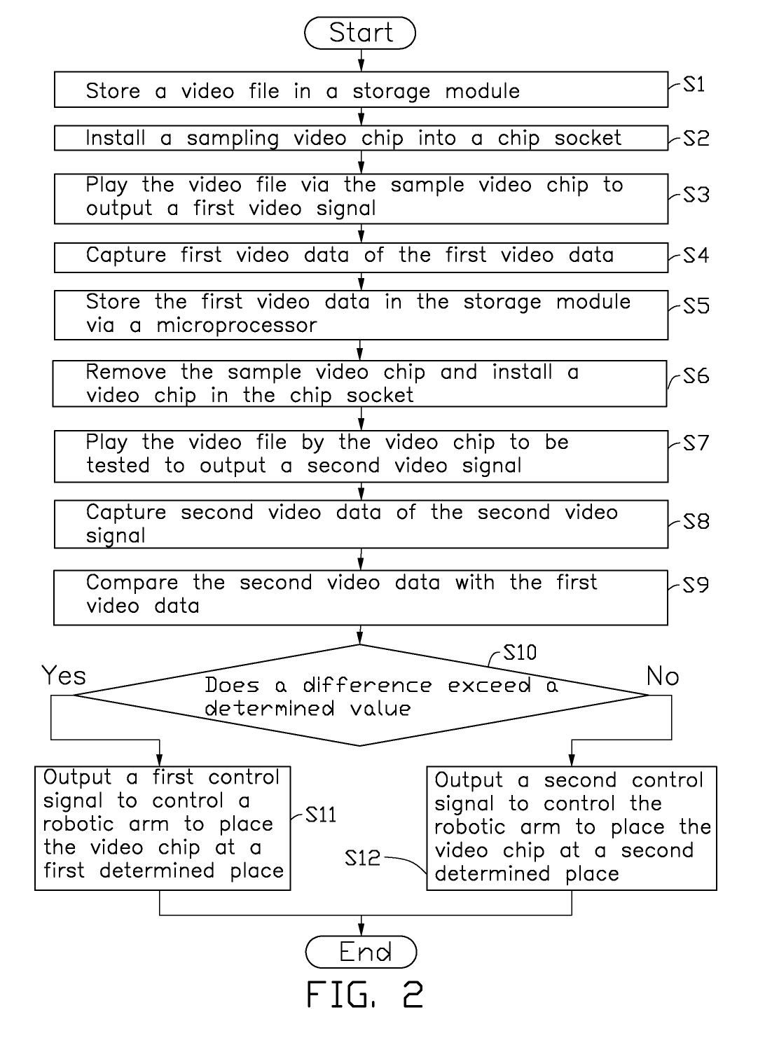

Referring to FIG. 2, a testing method for the video chip employed by the system 100 includes the following steps.

In step S1, the storage module 10 stores a video file.

In step S2, an acceptable video chip functioning as a sample video chip is installed to the chip socket 20.

In step S3, the sample video chip plays the video file and outputs a first video signal.

In step S4, the video capture module 50 captures first video data of the first video signal and transmits the first video data to the microprocessor 60.

In step S5, the microprocessor 60 stores the first video data in the storage module 10.

In step S6, the sample video chip is removed from the chip socket 20 and the video chip to be tested is installed in the chip socket 20.

In step S7, the video chip to be tested plays the video file and outputs a second video signal.

In step S8, the video capture module 50 captures second video data of the second video signal and transmits the second video data to the microprocessor 60.

In step S9, the microprocessor 60 compares the second video data with the first video data from the storage module 10.

In step S10, determine whether a difference between the second video data and the first video data exceeds a determined value or not.

In step S11, the microprocessor 60 determines the video chip to be tested is unacceptable and outputs a first control signal via the communication port 70 to control the robotic arm 80 to place the video chip at a first determined place, in response to the difference between the second and first video data exceeding a determining value.

In step S12, the microprocessor 60 determines the video chip to be tested is acceptable and outputs a second control signal via the communication port 70 to control the robotic arm 80 to place the video chip at a second determined place, in response to the difference between the second and first video data not exceeding a determining value.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A testing system for a video chip, comprising:
a storage module to store a video file;
a chip socket to install a sample video chip or a video chip to be tested; wherein the sample video chip plays the video file and outputs a first video signal in response to the sample video chip being installed to the chip socket, and the video chip to be tested plays the video file and outputs a second video signal in response to the video chip to be tested being installed to the chip socket;
a video capture module to capture first video data of the first video signal and second video data of the second video signal; and
a microprocessor to receive the first video data and store the first video data in the storage module, and to receive and compare the second video data with the first video data from the storage module to determine whether the video chip to be tested is acceptable or not.

2. The testing system of claim 1, wherein the storage module, the chip socket, the video capture module, and the microprocessor are all installed on a computer motherboard.

3. The testing system of claim 1, further comprises a robotic arm; wherein the microprocessor is operable to output a control signal via a communication port to control the robotic arm to place the tested video chip at a determined place after comparing the first video data and the second video data.

4. The testing system of claim 1, wherein the first video data and the second video data are in the same format.

5. The testing system of claim 1, wherein the first video data includes audio frequencies, video frequencies, and/or frame frequencies.

6. A testing method for a video chip, comprising:
storing a video file in a memory system;
installing a sample video chip to a chip socket;
playing the video file via the sample video chip to output a first video signal;
capturing first video data of the first video signal via a video capture module and transmitting the first video data to a microprocessor;
storing the first video data in the memory system via the microprocessor;
removing the sample video chip from the chip socket and installing a video chip to be tested to the chip socket;
playing the video file via the video chip to be tested to output a second video signal;
capturing second video data of the second video signal via the video capture module and transmitting the second video data to the microprocessor; and
comparing the second video data with the first data from the memory system by the microprocessor, to determine whether the video chip to be tested is acceptable or not.

7. The testing method of claim 6, further comprising:
determining that the video chip is unacceptable in response to a difference between the second video data and the first video data exceeding a determined value; and
determining that the video chip to be tested is acceptable in response to the difference between the second video data and the first video data not exceeding the determined value.

8. The testing method of claim 7, further comprising:
outputting a first control signal to control a robotic arm via a communication port to place the tested video chip at a first determined place, in response to the video chip to be tested being determined to be unacceptable.

9. The testing method of claim 8, further comprising:
outputting a second control signal to control a robotic arm via a communication port to place the tested video chip at a second determined place in response to the video chip to be tested being determined to be acceptable.

10. The testing method of claim 6, wherein the chip socket is installed on a computer motherboard.
